(19) United States
(12) Patent Application Publication
(10) Pub. No.: US 2006/0067211 A1
(43) Pub. Date: Mar. 30, 2006

(54) Node device, communication system and method for redundancy configuration

(75) Inventor: Naokatsu Ohkawa, Yokohama (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/018,039

(22) Filed: Dec. 21, 2004

(30) Foreign Application Priority Data
Sep. 27, 2004 (JP) 2004-279321

(51) Int. Cl. H04L 1/00

(52) U.S. Cl. 370/223; 370/248

(57) ABSTRACT

The present invention relates to a node device applied to BLSR, a communication system containing the node device and a redundancy configuration method for the node device. An object of the invention is to keep simplicity of 2F-BLSR, and implement span switching at the same level as that of 4F-BLSR. Therefore, the invention is equipped with a controller which substitutes when a failure occurs in a preceding transmission section of any one of the plural annular transmission lines but not in the rest of them, any reserve band of the rest of the annular transmission lines for the active band of the preceding transmission section with the failure therein.

### CROSS REFERENCE TO RELATED APPLICATION

This application is based upon and claims the benefit of priority from Japanese Patent Application No. 2004-279321, filed on Sep. 27, 2004, the entire contents of which are incorporated herein by reference.

### BACKGROUND OF THE INVENTION

1. Field of the Invention

The present invention relates to a node device equipped to a transmission system as BLSR (Bi-directional Line Switched Ring), and it relates to a communication system containing the node device and a redundancy configuration method for the node device.

2. Description of the Related Art

SONET (Synchronous Optical NETwork) and SDH (Synchronous Digital Hierarchy) are applied to many basic transmission systems because they are suitably applicable to architecture of high-speed networks by practically using high transmission speed and other advantages of optical fibers and many functions associated with maintenance and operation are installed in them. Furthermore, high reliability can be secured for SONET and SDH because backup adapted to line failures is carried out by a protection function described later which is one of the functions associated with maintenance and operation, for example.

FIG. 6 is a diagram showing a first configuration of BLSR for implementing the protection function.

BLSR shown in FIG. 6 is configured by disposing four node devices 32-A to 32-D on two optical fibers 31-1, 31-2 so that they are respectively annularly laid down and the transmission directions thereof are opposite to each other, and it is called as 2F-BLSR (2 Fiber Bi-directional Line Switched Ring).

The node device 32-A is equipped with interface portions (INF) 33-A1 connected to the incoming route corresponding to a preceding transmission section of the optical fiber 31-1 and also connected to the outgoing route corresponding to a subsequent transmission section of the optical fiber 31-1, and interface portions (INF) 33-A2 connected to the incoming route corresponding to a preceding transmission section of the optical fiber 31-2 and the outgoing route corresponding to a subsequent transmission section of the optical fiber 31-2. Each of these interface portions 33-A1 and 33-A2 is composed of portions for preceding and subsequent transmission sections which are associated with the incoming route and the outgoing route, respectively. The portion for preceding transmission section of each of the interface portions 33-A1, 33-A2 is connected to first to fourth input ports of a switch 34-A. A first output port out of four output ports equipped to the switch 34-A is connected to the corresponding input of a span switch (SPAN) 35-A1, and the fourth output port is connected to the corresponding input of a span switch (SPAN) 35-A2. The outputs of the span switches 35-A1 and 35-A2 and the second and third output ports of the switch 34-A are connected to the corresponding input ports of a switch 36-A. The first and second output ports of the switch 36-A are connected to the corresponding inputs of a ring switch (RING) 37-A1, and the third and fourth output ports of the switch 36-A are connected to the corresponding inputs of a ring switch (RING) 37-A2. The outputs of the ring switches 37-A1, 37-A2 are connected to the corresponding input ports of a cross-connect switch (XC) 38-A, and the first and second output ports of the cross-connect switch 38-A are connected to the portion for subsequent transmission section of each of the above-described interface portions 33-A1, 33-A2. The control terminals of the interface portions 33-A1, 33-A2, the switch 34-A, the span switches 35-A1, 35-A2, the switch 36-A, the ring switches 37-A1, 37-A2 and the cross-connect switch (XC) 38-A are connected to the corresponding input/output ports of a controller 39-A.

The configurations of the node devices 32-B, 32-C, 32-D are the same as the configuration of the node device 32-A, and reference numerals added with suffices “B” to “D” in place of the suffix “A” are used in the following description. Therefore, the description and drawings associated with the same elements are omitted.

In 2F-BLSR thus configured, the transmission band of the optical fiber 31-1, 31-2 is beforehand distributed to a work channel supplied to living transmission (a channel which is being actually used for transmission) and a protection channel supplied as a substitute (backup) of a living line when some trouble occurs or the like. In a case where OC192 is applied to the optical fibers 31-1, 31-2, when the number of channels formed in each of the optical fibers 31-1, 31-2 is equal to 192, the work channel and the protection channel are set to first to 96-th channels (indicated by a solid line of FIG. 6) and 97-th to 192nd channels (indicated by a broken line of FIG. 6), respectively.

For example, when the optical fiber 32-2 is broken or suffers some other trouble in the section extending from the node device 32-A to the node 32-D as shown in FIG. 6, a living line which is formed through the optical fiber 31-2 and extends from the node device 32-A through the node device 32-D to the node device 32-C (formed through the work channel) is relieved by carrying out ring switching, that is, by substituting for the active band a combination of a substitute link formed in the section extending from the node device 32-A through the node device 32-B and the node device 32-C to the node device 32-D by applying the protection channel of the optical fiber 31-1 as indicated by a heavy solid line of FIG. 6 and a substitute link extending from the node device 32-D through the work channel to the node device 32-C as indicated by a heavy solid line of FIG. 6.

FIG. 7 is a diagram showing a second configuration of BLSR for implementing the protection function.

BLSR shown in FIG. 7 is configured by disposing four node devices 42-A to 42-D on four optical fibers 41-1 to 41-4 so that they are respectively annularly laid down and the transmission directions thereof are alternately reversed, and it is called as 4F-BLSR (4 Fiber Bi-directional Line Switched Ring).

The node device 42-A is equipped with the following interface portions (INF) 43-A1 to 43-A4.

(1) The interface portions 43-A1 connected to the incoming route corresponding to a preceding transmission section of the optical fiber 41-1 and the outgoing route corresponding to a subsequent transmission section.

(2) The interface portions 43-A2 connected to the incoming route corresponding to a preceding transmission section of the optical fiber 41-2 and the outgoing route corresponding to a subsequent transmission section.

(3) The interface portions 43-A3 connected to the incoming route corresponding to a preceding transmission section of the optical fiber 41-3 and the outgoing route corresponding to a subsequent transmission section.

(4) The interface portions 43-A4 connected to the incoming route corresponding to a preceding transmission section of the optical fiber 41-4 and the outgoing route corresponding to a subsequent transmission section.

Each of these interface portions 43-A1 to 43-A4 is composed of a portion for preceding transmission section and a portion for subsequent transmission section which correspond to the incoming route and the outgoing route, respectively. A switch 44-A is connected to the portions for preceding transmission section of the interface portions 43-A1 to 43-A4. First and second output ports out of eight output ports equipped to the switch 44-A are connected to the corresponding inputs of a span switch (SPAN) 45-A1, and third and fourth output ports are connected to the corresponding inputs of a span switch (SPAN) 45-A2. Furthermore, fifth and sixth output ports are connected to the corresponding inputs of a span switch (SPAN) 45-A3, and seventh and eighth output ports are connected to the corresponding inputs of a span switch (SPAN) 45-A4. The outputs of the span switches 45-A1 to 45-A4 and the second, third, sixth and seventh output ports of the above switch 44-A are connected to the corresponding input ports of a switch 46-A. The first and second output ports of the switch 46-A are connected to the corresponding inputs of a ring switch (RING) 47-A1, and the third and fourth output ports of the switch 46-A are connected to the corresponding inputs of a ring switch (RING) 47-A2. Furthermore, the fifth and sixth output ports of the switch 46-A are connected to the corresponding inputs of a ring switch (RING) 47-A3, and the seventh and eighth output ports of the switch 46-A are connected to the corresponding inputs of a ring switch (RING) 47-A4. The outputs of the ring switches 47-A1 to 47-A4 are connected to the corresponding input ports of a cross-connect switch (XC) 48-A, and the first to fourth output ports of the cross-connect switch are connected to the portions for subsequent transmission section of the above-described interface portions 43-A1 to 43-A4. Furthermore, the control terminals of the interface portions 43-A1 to 43-A4, the switch 44-A, the span switches 45-A1 to 45-A4, the switch 46-A, the ring switches 47-A1 to 47-A4 and the cross-connect switch (XC) 48-A are connected to the corresponding input/output ports of a controller 49-A.

The configurations of the node devices 42-B, 42-C, 42-D are the same as that of the node device 42-A, and reference numerals added with suffices “B” to “D” in place of the suffix “A” are used in the following description. Therefore, the duplicative description and drawings on the same elements are omitted.

In 4F-BLSR thus configured, each of the transmission band of the optical fiber 41-1, 41-2 and the transmission band of the optical fiber 41-3, 41-4 is distributed to a work channel and a protection channel as described above.

Accordingly, when the optical fiber 42-2 is broken or suffers some other trouble in the section extending from the node device 32-A to the node 32-D, a living line which is formed through the optical fiber 41-2 and extends from the node device 42-A through the node device 42-D to the node device 42-C (formed through the work channel) is relieved by carrying out span switching, that is, by substituting for the active band a combination of a substitute link formed in the section extending from the node device 42-A to the node device 42-D by applying the transmission band (for which the protection channel is formed) of the optical fiber 41-4 substituted for the optical fiber 41-2 as indicated by a heavy solid line of FIG. 7 and a link formed so as to extend from the node device 42-D through the optical fiber 41-2 to the node device 42-C as indicated by a heavy solid line of FIG. 7.

Accordingly, 4F-BLSR secures higher durability to troubles as compared with 2F-BLSR in which the work channel having a trouble therein is relieved by the ring switching described above.

In the following description, common matters to the node devices 32-A to 32-D (42-A to 42-D) will be described by using reference numerals added with a suffix “x” as a first suffix, which means that these matters are satisfied for all the suffixes “A” to “D”.

Furthermore, in 2F-BLSR and 4F-BLSR, the ring switching and the span switching described above are implemented by cooperating the respective parts shown in FIGS. 6 and 7 with one another as follows.

The portions for preceding transmission section of the interface portions 33-x1, 33-x2 (43-x1 to 43-x4) take frames received through preceding transmission sections of the corresponding optical fibers, and deliver the headers of the frames and the contents of fields to the controller 39-x (49-x) and the switch 34-x (44-x).

The controller 39-x (49-x) analyzes the contents of the headers thus delivered (containing K1 byte and K2 byte described later), etc., and overall controls the operations of the interface portions 33-x1, 33-x2 (43-x1 to 43-x4), the switch 34-x (44-x), the span switches 35-x1, 35-x2 (45-x1 to 45-x4), the switch 36-x (46-x), the ring switches 37-x1, 37-x2 (47-x1 to 47-x4) and the cross-connect switch 38-x (48-x) on the basis of the above analysis result.

The switch 34-x (44-x) operates as a switch for a complete group every half of the transmission band of the optical fiber 31-1, 31-2 (41-1 to 41-4).

The span switches 35-x1, 35-x2 (45-x1 to 45-x4) and the ring switches 37-x1, 37-x2 (47-x1 to 47-x4) deliver any one of the bands given through the two corresponding output ports of the switch 34-x (44-x) (corresponding to the halves of the transmission bands of the optical fibers 31-1, 31-2 (41-1 to 41-4)) to the switch 36-x (46-x).

The switch 36-x (46-x) operates as a switch for a complete group under the control of the controller 39-x (49-x) every half of the transmission band of the optical fiber 31-1, 31-2(41-1 to 41-4) (given as a band delivered through the switch 36-x (46-x) and a band directly delivered from the port of the switch 34-x (44-x).

The ring switches 37-x1, 37-x2 (47-x1 to 47-x4) combine the bands delivered through the two corresponding ports of the switch 36-x (46-x) (each of which corresponds to the double of the half band described above and equal to the transmission band of the subsequent transmission section).

The cross-connect switch 38-x (48-x) operates as a switch for a complete group for determining the connection between the band which is delivered through the combination of the ring switches 37-x1, 37-x2 (47-x1 to 47-x4) and equal to the transmission band of the subsequent transmission section and the portion for subsequent transmission section of the interface portion 33-x1, 33-x2 (43-x1 to 43-x4).

The K1 byte and the K2 byte described above are composed for the following information assemblies, and they are analyzed by the controller 39-x (49-x) and also referred to in the course of the processing based on the analysis result.

The K1 byte is composed of an upper K1 byte having a length of 4 bits (FIG. 8(1)) indicating a switch request as a type of switch formed between the preceding transmission section and the subsequent transmission section in the node devices 32-A to 32-D (42-A to 42-D), and a lower K1 byte having a length of 4 bits (FIG. 8(2)) indicating identification information on a destination node device (hereinafter referred to as destination identification information).

(1) SF-P/LP-S (Signal fail-protection/Lockout of protection-span)

[Request for notification of trouble (breaking of line or the like) occurring in protection channel to neighboring node device through subsequent transmission section]/[request for prohibition of use of span and prohibition of ring switching to all protection channels]

(2) FS-S (Forced swith-span)

Request for span switching

(3) FS-R (Forced swith-ring)

Request for substitution of work channel (ring switching) by protection channel

(4) SF-S (Signal fail-span)

Request for detecting attenuation (lack) of signal or frame, bit error rate exceeding predetermined threshold value and trouble of hardware, and forming a bridge suitable for the trouble

(5) SF-R (Signal fail-ring)

Request for detecting attenuation (lack) of signal or frame, bit error rate exceeding predetermined threshold value and trouble of hardware, and forming a bridge suitable for the trouble

(6) SD-P (Signal degrade-protection)

Request for span switching of protect channel in which bit error rate exceeds predetermined threshold value

(7) SD-S (Signal degrade-span)

Request for span switching of channel in which bit error rate exceeds predetermined threshold value

(8) SD-R (Signal degrade-ring)

Request for ring switching of channel in which bit error rate exceeds predetermined threshold value

(9) MS-S (Manual Switch-span)

Request (for span switching) based on operator's instruction

(10) MS-R (Manual switch-ring)

Request (for ring switching) based on operator's instruction

(11) WTR (Wait to restore)

Request for keeping the present situation over predetermined period unless there is no other request having a higher priority (which is issued when work channel can be restored from trouble)

(12) EXE-S (Exercise-span)

Request for span switching followed by neither physical bridge not switching

(13) EXE-R (Exercise-ring)

Request for ring switching followed by neither physical bridge nor switching

(14) RR-S (Reverse request-span)

Acknowledge for receiving a request for short path span bridge

(15) RR-R (Reverse request-ring)

Acknowledge for receiving a request for short path ring bridge

(16) NR (None Request)

Neither effective request nor acknowledgement

K2 byte is composed of upper K2 byte having a length of 4 bits representing identification information of a node device at a transmitting end (hereinafter referred to as transmitting end identification information paired with the destination node described above and lower K2 byte containing PATH bit of 1 bit in length and switch status of 3 bits in length described later.

PATH bit indicates with a logic value “0” (=S) that the number of hops (the number of node devices interposed) on the corresponding optical fiber out of the optical fibers 31-1, 31-2 (41-1, 41-4) is minimum, or indicates with a logic value “1” (=L) that the number of hops is not minimum.

Switch status indicates any state of the following matters.

(1) AIS (Alarm Indication Signal)

State where trouble occurs

(2) RDI (Remote Failure Detection)

State where trouble is detected in confronting node device through channel

(3) Extra Traffic

State where communications are made through protection channel

(4) BrSw (Bridge & Switch)

State where bridge switch is formed as indicated by heavy broken line in FIG. 7

(5) Br (Bridge)

State where bridge is formed

(6) Idle

State out of the above states

As a prior art relating to the invention is a known bi-directional ring switching method in which when a span switch is carried out to relieve a trouble detected by its own node constituting a ring of a bi-directional ring switching system composed of plural fibers, however it is not normally carried out, it is carried out by changing the span switch to a ring switch, the bi-directional ring switching method being characterized in that when its own node receives a span switch request which has a priority higher than that of the ring switch and occurs in another node, the ring switch request is kept as an internal request.

4-FBLSR has higher durability to troubles than 2F-BLSR as described above. However, in 2F-BLSR, the controllers 49-A to 49-D must execute the processing corresponding to many requests which are not set as upper K1 byte as underlined in FIG. 8.

Accordingly, in 4-FBLSR, both the configuration of software installed in the controllers 49-A to 49-D and the procedure for implementing the protection function are more complicated as compared with 2F-BLSR, and also a large processing amount of several times is needed to the controllers 49-A to 49-D.

In the prior arts, the value “1111” of the upper K1 byte means both of SF-P (Signal fail-protection) and LP=S (Lockout of protection-span) as described above. Accordingly, for example when command LP-S is input to the node device 42-B, the node device 42-A receives command SF-P (Signal fail-protection) transmitted by the node device 42-B in response to the command LP-S, and transmits command SF-R (Signal fail-ring) to a subsequent transmission section ((formed between the noted device 42-A and each of the node devices 42-B, 42-D) in response to the command SF-P. The node device 42-B makes no response to the command SF-R (Signal fail-ring) because it is executing the command LP-S described above, so that the ring switching is not performed.

However, the node device 42-C, 42-D is set to a fiber through state in response to the command SF-R (Signal fail-ring), and thus there may occur an abnormal state where there exists a node device under such a fiber through state as described above although the ring switching is not carried out.

Furthermore, according to the prior arts, in order to upgrade 2F-BLSR to 4F-BLSR without stopping the operation, a cumbersome work based on the following proceedings (1) to (5) must be carried out on all the node devices 42-A to 42-D.

(1) By manually executing the ring switching before the slot position of an interface portion at a west side is changed, transmission of a signal delivered through the interface portion is substituted by a slot at an east side (FIG. 10(a)).

(2) The ring switching is released after the interface portion at the west side is shifted to an adjacent slot 3 for expansion (FIG. 10(b)).

(3) An interface portion is added to each of the slots 2, 4 corresponding to protection channels at the east side and west side (FIG. 10(c)).

(4) The setting of the cross connects set for the protection channel is shifted to the slots 2, 4 corresponding to the above protection channels (FIG. 10(d)). For example, when applied to OC192, work channels (first to ninety seventh channels) connected to the interface portion mounted in the slot 1 are shifted to the same channel of the slot 2.

(5) The setting of each part is shifted form the setting for 2F-BLSR to the setting for 4F-BLSR.

### SUMMARY OF THE INVENTION

The invention has an object to provide a node device, a communication system and a redundancy configuration method for realizing span switching of the same level as that of 4F-BLSR without impairing simplicity of 2F-BLSR.

Furthermore, another object of the invention is to enhance reliability of a communication system at low cost without basically changing a protection function which is originally applied to plural annular transmission lines.

A further object of the invention is to relieve a failure occurring in a transmission section of any of plural annular transmission lines by preferentially using reserve bands of annular transmission lines without a failure to a reserve band of the transmission section with the failure.

A further object of the invention is to relieve a failure occurring in a transmission section of any of plural annular transmission lines without using annular transmission lines with no failure, if reserve bands of the annular transmission lines are not surely secured.

A further object of the invention is to guarantee the compatibility between status information and a transmission system for delivering the status information and to relieve failures at low cost.

A further object of the invention is to effectively use the band of an annular transmission line with no failure for the ring switching even when annular transmission lines as subjects of ring switching may be greatly different.

A further object of the invention is to realize, within a limited cost, a communication system in which redundantly configured transmission sections are only ones required to have high reliability.

The summary of the invention is as follows.

According to a first aspect of the invention, a node device is disposed in each of plural annular transmission lines whose transmission bands are assigned to an active band and a reserve band. Each annular transmission line is bi-directionally formed of two optical fibers for transmission in different directions from each other. The node device includes a controller which substitutes, when a failure occurs in a preceding transmission section of any of the plural annular transmission lines but not in the rest of the annular transmission lines, any reserve band of the rest of the annular transmission lines for the active band of the preceding transmission section with the failure therein.

That is, even when some failure occurs in the preceding transmission section, the active band thereof is substituted by a reserve band of any of the rest of the annular transmission lines which are not having a failure.

According to a second aspect of the invention, when a failure occurs in a preceding transmission section of any of the plural annular transmission lines as well as in the rest of the annular transmission lines, the controller substitutes a reserve band of a subsequent transmission section to the preceding transmission section for the active band of the preceding transmission section.

That is, if a failure occurs in the preceding transmission section of one of the annular transmission lines, the active band thereof can be substituted by the reserve band of a transmission section subsequent to the preceding transmission section, even if there are no other annular transmission lines with no failure.

According to a third aspect of the invention, the controller identifies, as a combination of status information delivered among node devices disposed in the plural annular transmission lines, a situation that no failure occurs in the rest of the annular transmission lines. Through the preceding transmission section it issues a request for the substitution of the active band of the preceding transmission section to the other node devices and receives a response to the request from the other node devices. The request and response are reserved pieces of the status information.

That is, during the process of the failure relief according to the first and second aspects of the invention described above, the controller cooperates with the other node devices via the channel for transmission of the above information, without the need to add a new channel designated for the cooperation.

According to a fourth aspect of the invention, given a ring switching request through a preceding transmission section of the plural annular transmission lines or from an exterior, the controller cooperates with the other nodes prior to a start of the ring switching through an annular transmission line which is not subject of the ring switching and is one with no failure.

That is, the aforementioned ring switching can be started with sureness through the cooperation of the node devices involved with the ring switching via the annular transmission lines with no failure.

According to a fifth aspect of the invention, plural first node devices are according to the first to fourth aspects of the invention described above and disposed in plural annular transmission lines whose transmission bands are assigned to active and reserve bands and each of which are bi-directionally formed of two optical fibers for transmission in different directions from each other. Second node devices are disposed in plural annular transmission lines which are formed as BLSR.

That is, among the transmission sections of the plural annular transmission lines, one which is sandwiched among the plural first node devices and in which no second node device is present is redundantly configured the same as the plural annular transmission lines of the first to fourth aspects of the invention.

### BRIEF DESCRIPTION FO THE DRAWINGS

The nature, principle, and utility of the invention will become more apparent from the following detailed description when read in conjunction with the accompanying drawings in which like parts are designated by identical reference numbers, in which:

FIG. 1 is a diagram showing first to third embodiments of the invention;

FIG. 2 is a diagram showing the operation of the first and second embodiments;

FIG. 3 is a diagram showing the configurations of K1 byte and K2 byte according to the first embodiment of the invention;

FIG. 4 is a diagram showing the third embodiment of the invention;

FIG. 5 is a diagram showing the third embodiment of the invention;

FIG. 6 is a diagram showing a first configuration of BLSR for implementing a protection function;

FIG. 7 is a diagram showing a second configuration of BLSR for implementing the protection function;

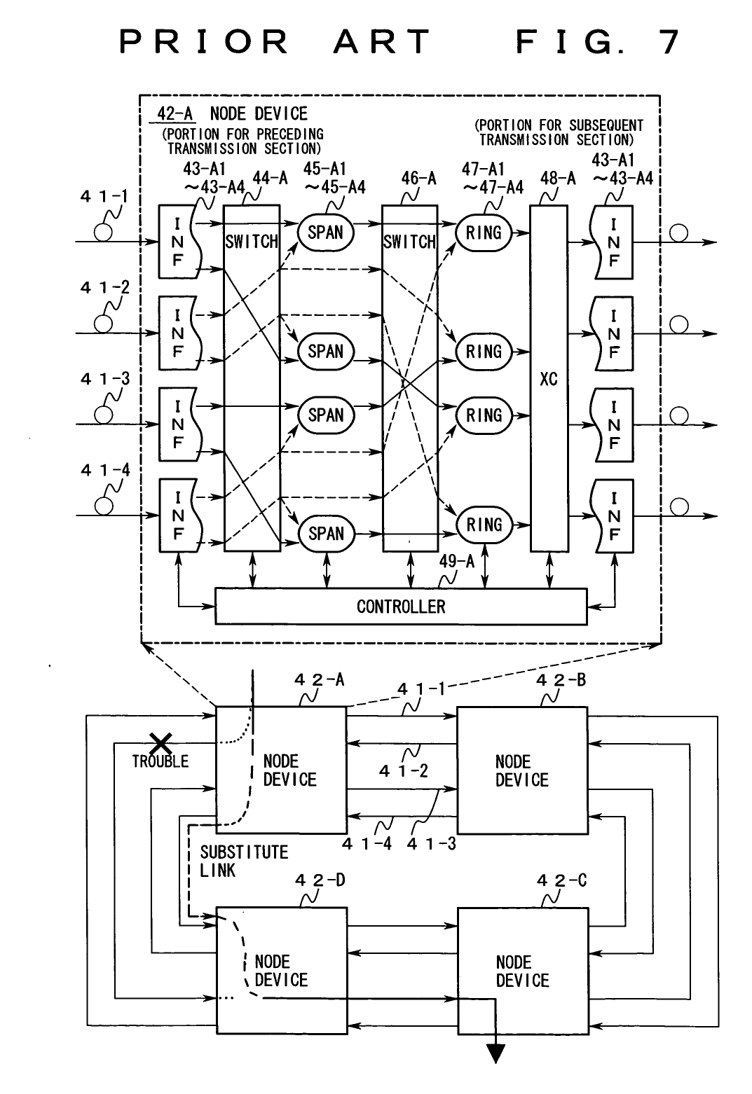

FIG. 8 is a diagram showing the configurations of K1 byte and K2 byte of a prior art;

FIG. 9 is a diagram showing a problem of the prior art; and

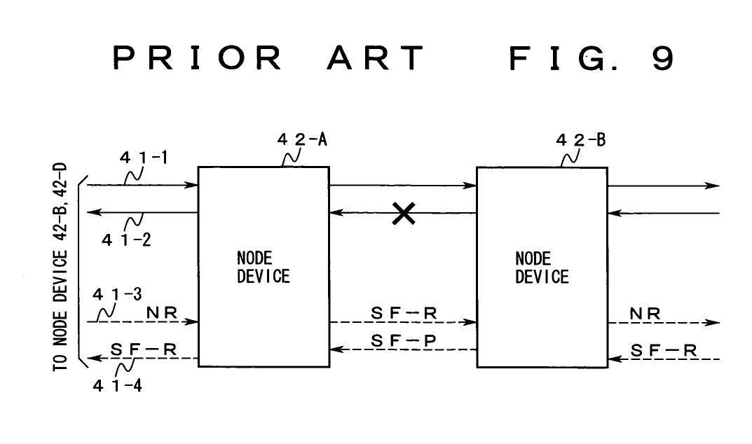

FIGS. 10(a) to 10(d) are diagrams showing an upgrading procedure of the prior art.

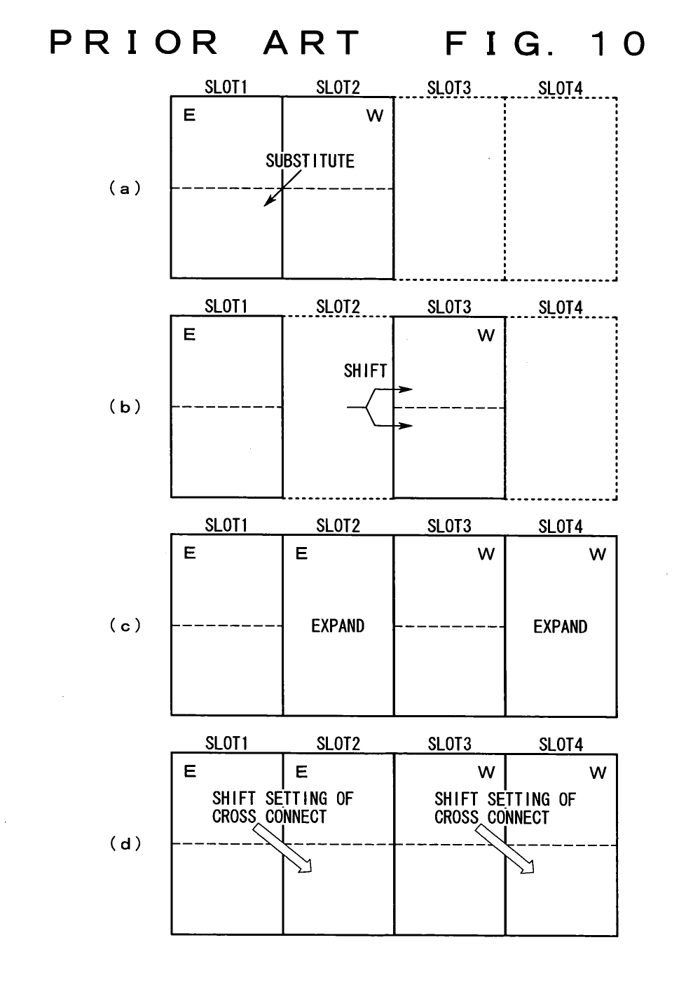

### DESCRIPTION OF THE PREFERRED EMBODIMENTS

Preferred embodiments according to the invention will be described hereunder with reference to the accompanying drawings.

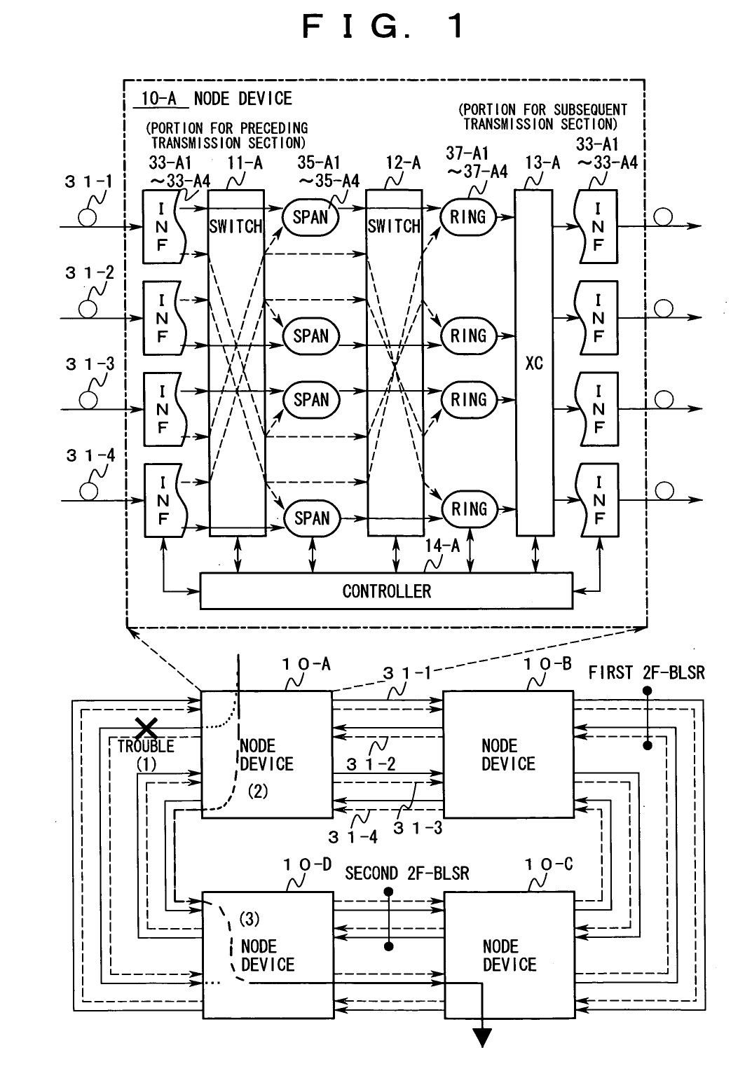

FIG. 1 is a diagram showing first to third embodiments of the invention.

In FIG. 1, each of four optical fibers 31-1 to 31-4 is annularly laid down, and the transmission directions of these fibers are alternately reversed in the order of suffix numbers “1” to “4” added to reference numeral “31”. Four node devices 10A to 10D are disposed in an annular transmission line formed of these optical fibers 31-1 to 31-4.

The node device 10-A is equipped with the following interface portions (INF) 33-A1 to 33-A4.

(1) Interface portions 33-A1 connected to the incoming route corresponding to a preceding transmission section of the optical fiber 31-1 and the outgoing route corresponding to a subsequent transmission section

(2) Interface portions 33-A2 connected to the incoming route corresponding to a preceding transmission section of the optical fiber 31-2 and the outgoing route corresponding to a subsequent transmission section

(3) Interface portions 33-A3 connected to the incoming route corresponding to a preceding transmission section of the optical fiber 31-3 and the outgoing route corresponding to a subsequent transmission section

(4) Interface portions 33-A4 connected to the incoming route corresponding to a preceding transmission section of the optical fiber 31-4 and the outgoing route corresponding to a subsequent transmission section

Each of these interface portions 33-A1 to 33-A4 comprises the portion for preceding transmission section and the portion for subsequent transmission section which correspond to the incoming route and the outgoing route described above, respectively. A switch 11-A is connected to the portions for preceding transmission section of the interface portions 33-A1 to 33-A4 as described above. The first and second output ports out of eight output ports equipped to the switch 11-A are connected to the corresponding inputs of a span switch (SPAN) 35-A1, and the third and fourth output ports are connected to the corresponding inputs of a span switch (SPAN) 35-A2. Furthermore, the fifth and sixth output ports are connected to the corresponding inputs of a span switch (SPAN) 35-A3, and the seventh and eighth output ports are connected to the corresponding inputs of a span switch (SPAN) 35-A4. The outputs of the span switches 35-A1 to 35-A4 and the second, third, sixth and seventh output ports of the switch 11-A described above are connected to the corresponding input ports of a switch 12-A. The first and second output ports of the switch 12-A are connected to the corresponding inputs of a ring switch (RING) 37-A1, and the third and fourth output ports of the switch 12-A are connected to the corresponding inputs of the ring switch (RING) 37-A2. Furthermore, the fifth and sixth output ports of the switch 12-A are connected to the corresponding inputs of the ring switch (RING) 37-A3, and the seventh and eighth output ports of the switch 12-A are connected to the corresponding inputs of a ring switch (RING) 37-A4. The outputs of the ring switches 37-A1 to 37-A4 are connected to the corresponding input ports of a cross-connect switch (XC) 13-A, and the first to fourth output ports of the cross-connect switch 13-A are connected to the portions for subsequent transmission section of the interface portions 33-A1 to 33-A4 described above. Furthermore, the control terminals of the interface portions 33-A1 to 33-A4, the switch 11-A, the span switches 35-A1 to 35-A4, the switch 12-A, the ring switches 37-A1 to 37-A4 and the cross-connect switch (XC) 13-A are connected to the corresponding input/output ports of a controller 14-A.

The configurations of the node devices 10-B, 10-C, 10-D are the same as the configuration of the node device 10-A. Therefore, in the following description, they are represented by using reference numerals added with suffix characters “B” to “D” in place of the suffix character “A”, and the duplicative description and illustrations thereof are omitted from the following description.

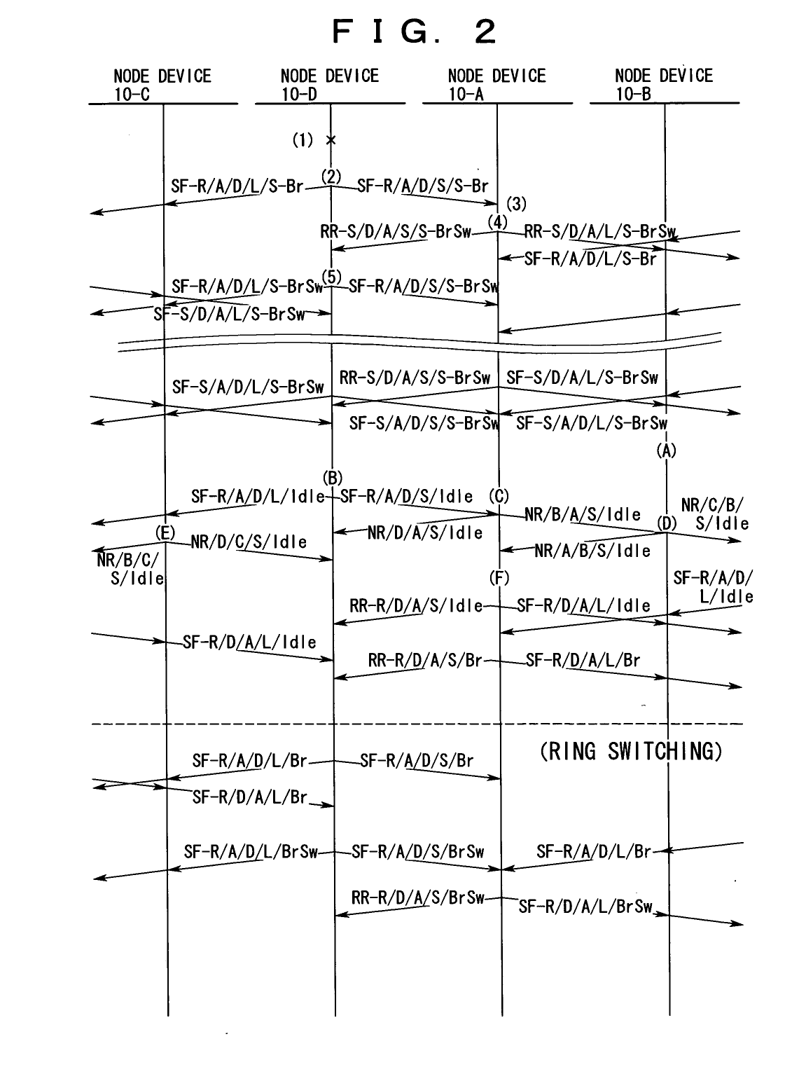

FIG. 2 is a diagram showing the operations of the first and second embodiments of the invention.

First, the operation of the first embodiment of the invention will be described hereunder with reference to the accompanying drawings.

The portions for preceding transmission section of the interface portions 33-A1 to 33-A4 take frames therein through preceding transmission sections of the optical fibers 31-1 to 31-4, and deliver the headers of the frames and the contents of the fields to the controller 13-A and the switch 11-A.

The controller 14-A analyzes the contents of the headers thus delivered (containing K1 byte and K2 byte described above) and overall controls the operation of the interface portions 33-A1 to 33-A4, the switch 11-A, the span switches 35-A1 to 35-A4, the switch 12-A, the ring switches 37-A1 to 37-A4 and the cross-connect switch 13-A on the basis of the analysis result, thereby forming a first 2F-BLSR in the optical fibers 31-1, 31-2 and also a second 2F-BLSR in the optical fibers 31-3, 31-4.

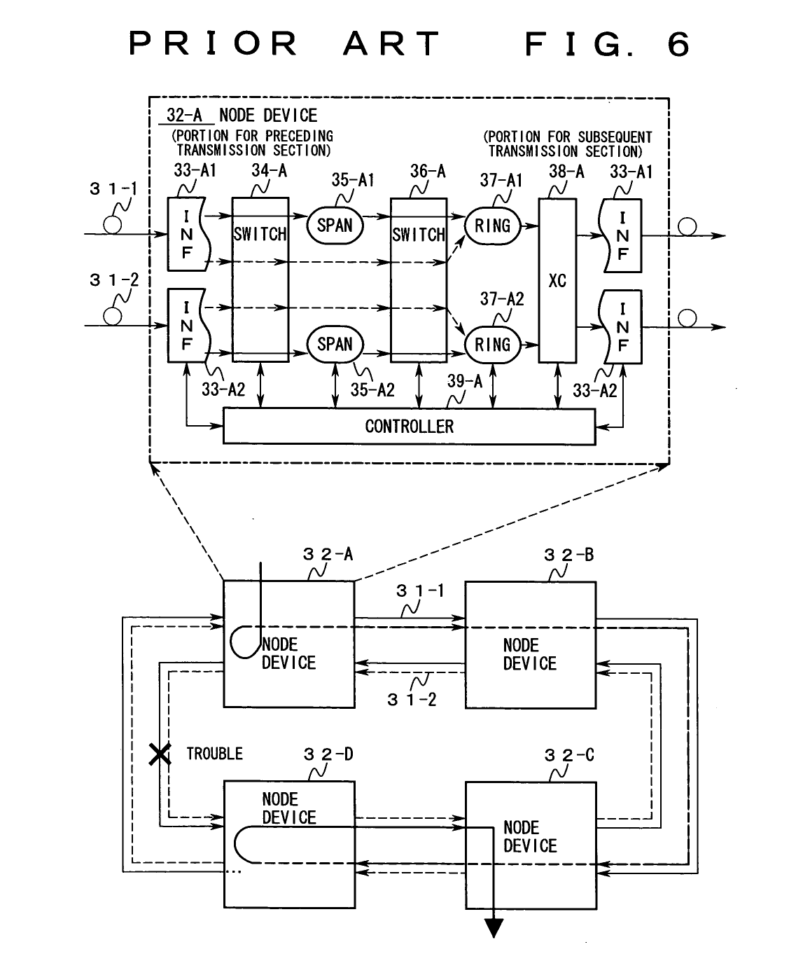

That is, under the state that no trouble occurs in the optical fibers 31-1 to 31-4, the switches 11-A, 12-A and the cross-connect switch 13-A function as the switches 34-A, 36-A and the cross-connect switch 38-A shown in FIG. 6 for the first 2F-BLSR under the overall control carried out by the controller 14-A. Furthermore, the interface portions 33-A3, 33-A4, the switches 11-A, the span switches 35-A3, 35-A4, the switch 12-A, the ring switches 37-A3, 37-A4 and the cross-connect switch 13-A function as the interface portions 33-A1, 33-A2, the switch 34-A, the span switches 35-A1, 35-A2, the switch 36-A, the ring switches 37-A1, 37-A2 and the cross-connect switch 38-A for the second 2F-BLSR.

In the following description, when the values of switch request, destination identifier, transmitting end identifier, PATH bit and switch status are equal to V1, V2, V3, V4 and V5 respectively, these values are represented by V1/V2/V3/V4/V5.

For example, when a trouble occurs in a transmission section from the node device 10-A to the node device 10-D out of the transmission sections of the optical fiber 31-2 (FIG. 1(1), FIG. 2(1)), these node devices 10-A, 10-D are cooperated with each other as follows.

(1) The node device 10-D detects a line trouble (SF: Signal Fail) indicating the trouble described above.

(2) Before the ring switching is carried out in connection with a line trouble in the case of the conventional 2F-BLSR, the node device 10-D identifies whether both the values of upper K1 byte received through an APS (Automatic Protection Switching) channel from the preceding transmission section of a second 2F-BLSR which is different from a first 2F-BLSR containing the optical fiber 31-2 having the line trouble concerned are equal to “NR” (it means that the second 2F-BLSR is normal).

(3) When any one of the values of upper K1 byte is not equal to “NR” (this means that a trouble also occurs in the second 2F-BLSR), by carrying out the ring switching in cooperation with the node device 10-A as in the case of the prior art, the transmission section in which the trouble occurs is relieved. In the process of the ring switching as described above, the switches 11-D, 11-A and the switches 12-D, 12-A function as the switches 34-D, 34-A and the switches 36-D, 36-A shown in FIG. 6 under the control of the controllers 14-D, 14-A.

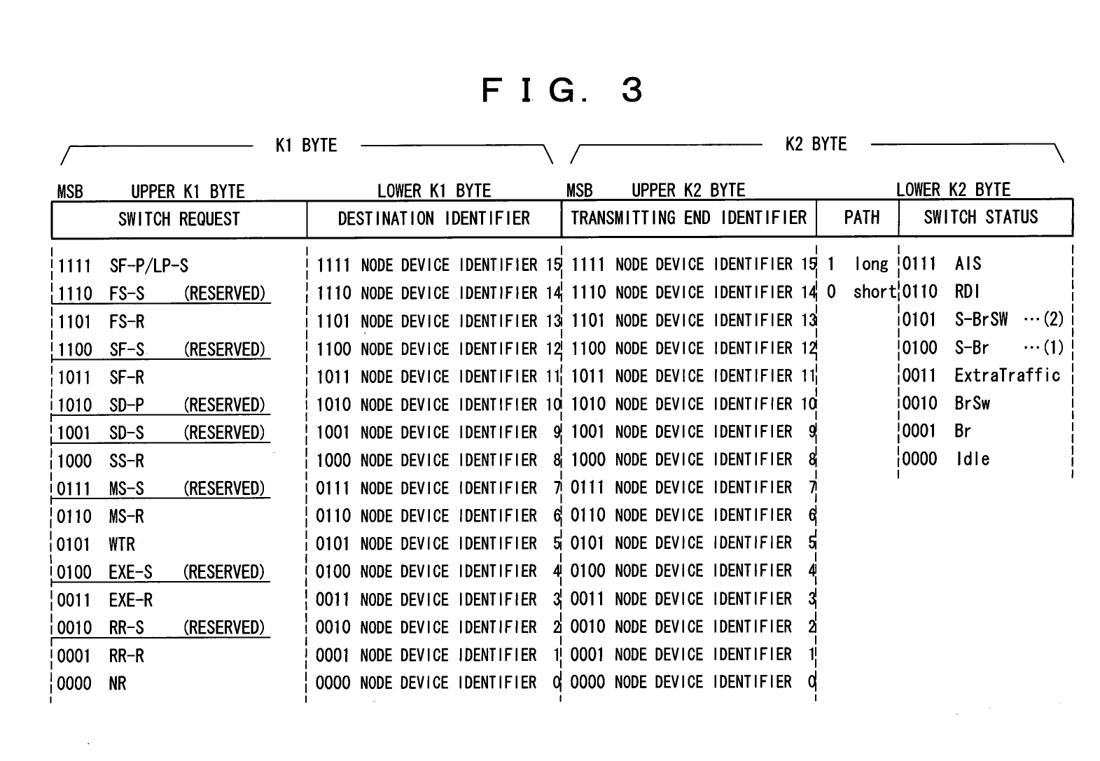

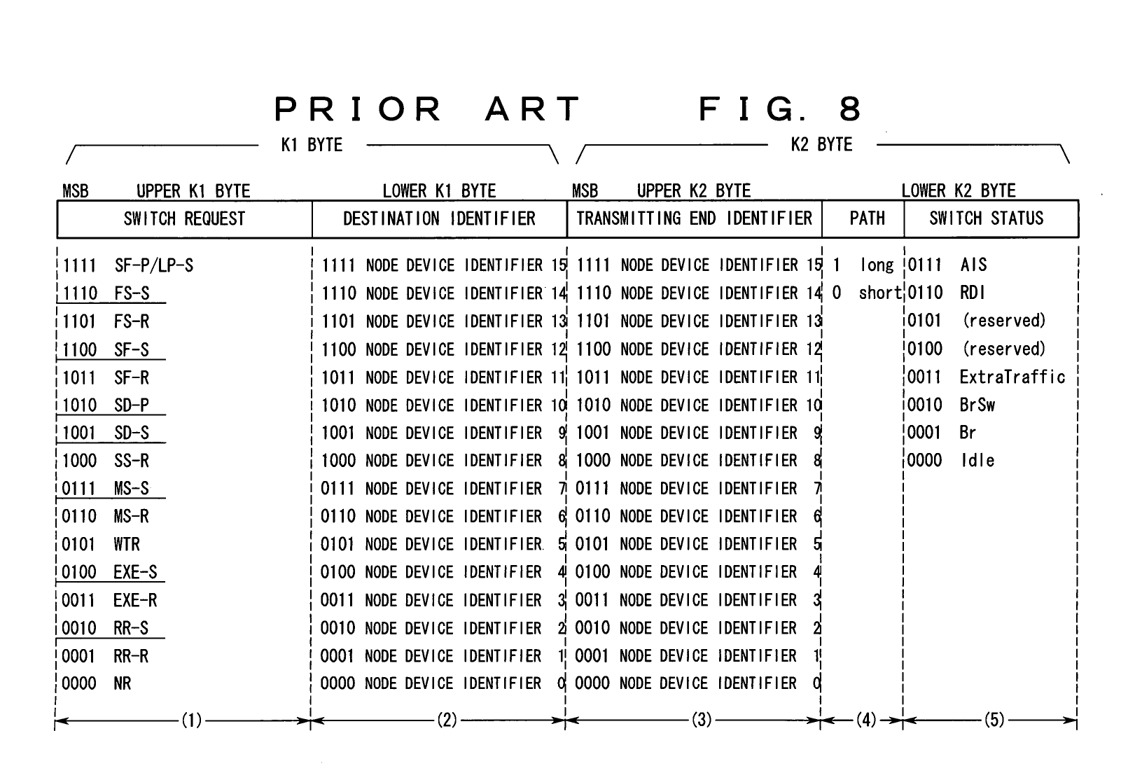

(4) However, when it is identified on the basis of the identification result that all the values of the upper K1 byte are equal to “NR”, the node device 10-D transmits the values of the K1 byte and the K2 byte indicating the identification result [SF-R/A/D/L/S-Br], [SF-R/A/D/S/S-Br] to the node device 10-A through the APS channel (FIG. 2(2)). S-Br is not defined as switch status shown in FIG. 8, however, it is represented as an unused (reserved) value “101” of the switch status as shown in FIG. 3(1) and means that the span switching from one of the first and second 2F-BLSRs to the other 2F-BLSR is possible (hereinafter referred to as span switching request).

(5) When the node device 10-A identifies the values of the K1 byte and K2 byte as described above, the node device 10-A judges whether the values of switch request received from the preceding transmission sections of the second 2F-BLSR through the APS channels are equal to “NR” (this means that the second 2F-BLSR is normal) (FIG. 2(3)).

(6) In the node device 10-A, when all the values of the switch request are equal to “NR”, the controller 14-A sets the states of the switches 11-A, 12-A and the span switches 35-A1 to 35-A4 to a state where the span switching from the first 2F-BLSR to the second 2F-BLSR is possible (FIG. 1(2)), and also transmits the values [RR-S/D/A/S/S-BrSw], [RR-S/D/A/L/S-BrSw] of the K1 byte and K2 byte meaning this state to the node device 10-D through the APS channel (FIG. 2(4)). S-BrSw is not defined as the switch status shown in FIG. 8, however, it is represented as an unused (reserved) value “101” of the switch status thereof as shown in FIG. 3(2) and means a normal response to the above span switching request (hereinafter referred to as span switching response).

(7) In the node device 10-D, when identifying such a span switching response, the controller 14-D sets the states of the switches 11-D, 12-D and the span switches 35-D1 to 35-D4 to a sate where the span switching from the second 2F-BLSR to the first 2F-BLSR can be carried out (FIG. 1(3)), and also transmits the values [SF-R/A/D/L/S-BrSw], [SF-R/A/D/S/S-BrSw] of K1 byte and K2 byte meaning the above state to the node device 10-A through the APS channel (FIG. 2(5)).

That is, the work channel formed in the optical fiber 31-2 in which a trouble occurs in the section from the node device 10-A to the node device 10-D is substituted by the protection channel formed in the optical fiber 31-4 as indicated by a heavy broken line in FIG. 1.

Accordingly, according to the invention, by combining the first and second 2F-BLSRs, the span switching adapted to the trouble can be implemented as in the case of the above-described 4F-BLSR without increasing the values to be possibly taken by the upper K1 byte (switch request) underlined in FIGS. 3 and 8 and the processing amount of the controllers 14-A to 14-D mounted in the node devices 10-A to 10-D.

### Second Embodiment

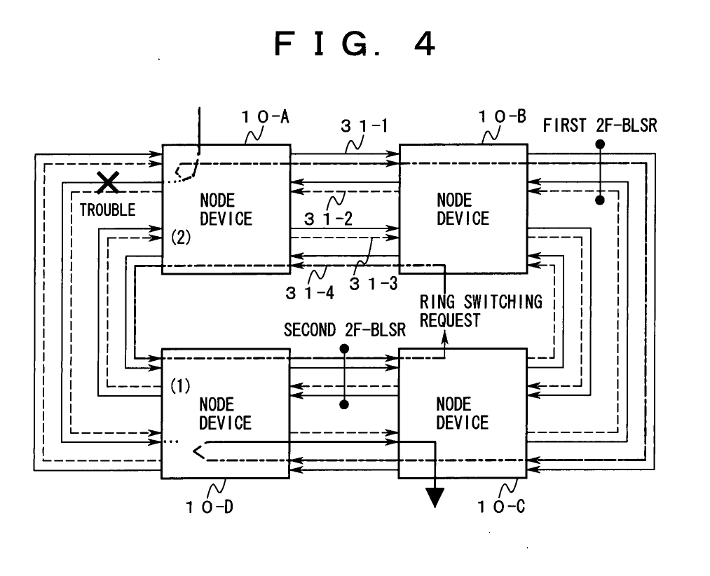

FIG. 4 is a diagram showing the operation of a second embodiment of the invention.

The operation of the second embodiment of the invention will be described with reference to FIGS. 1, 2 and 4.

The feature of this embodiment resides in the processing carried out in each node device in accordance with a ring switching request which is manually given to the node device 10-B for example and related to the second 2F-BLSR under the state that relief based on the span switching of a transmission section (extending from the transmission device 10-A to the transmission device 10-D) having a trouble occurring therein in the transmission sections of the optical fiber 31-2, and also in the procedure of the cooperation of these node devices.

In the following description, the common matters of the node devices 10-A to 10-D will be described by using reference numerals added with a suffix character “X” as a first suffix character which means that it corresponds to each of the suffix characters “A” to “D”.

(1) A node device 10-X (controller 14-X) monitors K1 byte and K2 byte received through bi-directional APS channels of first and second 2F-BLSR, and continues to relieve the above span switching during the period when no trouble occurs in the second 2F-BLSR under such a monitoring state.

(2) When a ring switching request relating to the above second 2F-BLSR is input to the node device 10-B under such a state (FIG. 2(A)), the node device 10-B transmits the values of the K1 byte and K2 byte [MS-R/C/B/L/S-Br], [MS-R/C/B/S/S-Br] indicating the above matter through the APS channel of the second 2F-BLSR to the node device 10-C. With respect to the K1 byte and K2 byte as described above, they are not transmitted through the first 2F-BLSR in which the ring switching is carried out, and thus the illustration thereof in FIG. 2 is omitted.

(3) When identifying [MS-R/C/B/S/S-Br] out of the values of the K1 byte and K2 byte as described above, the node device 10-D (controller 14-D) controls the switches 11-D, 12-D and the span switches 35-D1 to 35-D4 to release the state where the span switching from the second 2F-BLSR to the first 2F-BLSR can be maintained (FIG. 4(1)), and transmit the values of the K1 byte and K2 byte [SF-R/A/D/L/Idle], [SF-R/A/D/S/Idle] indicating the above fact (from span switching to ring switching) to the node device 10-A through the APS channel of the first 2F-BLSR (FIG. 2(B)).

(4) When identifying [SF-R/A/D/S/Idle] out of the values of these values of the K1 byte and K2 byte, the node device 10-A (controller 14-A) controls the switches 11-A, 12-A and the span switches 35-A1 to 35-A4 to release the state where the span switching from the first 2F-BLSR to the second 2F-BLSR can be maintained (FIG. 4(2)), and also transmit the values of the K1 byte and K2 byte [NR/D/A/S/Idle], [NR/B/A/S/Idle] indicating the fact (means completion of the processing needed for the change from span switching to ring switching) through the APS channel of the first 2F-BLSR and the adjacent node device 10-B (FIG. 2(C)).

(5) When identifying [NR/B/A/S/Idle] out of the values of K1 byte and K2 byte, the node device 10-B (controller 14-B) controls the switches 11-B, 12-B and the span switches 35-B1 to 35-B4 to release the state where the span switching from the first 2F-BLSR to the second 2F-BLSR can be maintained (this is limited to a case where such a state is precedently set) and transmit the values of K1 byte and K2 byte [NR/A/B/S/Idle], [NR/C/B/S/Idle] indicating the above fact through the APS channel of the first 2F-BLSR to the node device 10-A and the adjacent node device 10-C (FIG. 2(D)).

(6) When identifying [NR/C/B/S/Idle] out of the values of the K1 byte and K2 byte, the node device 10-C (controller 14-C) controls the switches 11-C, 12-C and the span switches 35-C1 to 35-C4 to release the state where the span switching from the first 2F-BLSR to the second 2F-BLSR can be maintained (this is limited to a case where such a state is precedently set, and also transmit the values of K1 byte and K2 byte [NR/B/C/S/Idle], [NR/D/C/S/Idle] indicating the above fact through the APS channel of the first 2F-BLSR to the node device 10-B and the adjacent node device 10-D (FIG. 2(E)).

(7) When identifying the values of K1 byte and K2 byte [SF-R/A/D/S/Idle] transmitted by the node device 10-D (controller 14-D) (FIG. 2(B)) as described above, the node device 10-A (controller 14-A) transmits the values of K1 byte and K2 byte [RR-R/D/A/S/Idle], [SF-R/D/A/L/Idle] indicating the above fact through the APS channel of the first 2F-BLSR to the node device 10-D and the adjacent node device 10-B (FIG. 2(F)).

(8) When identifying [RR-R/D/A/S/Idle] out of the values of K1 byte and K2 byte, the node device 10-D carries out ring switching in cooperation with the node devices 10-A, 10-B, 10-C through the APS channel of the first 2F-BLSR as in the case of the prior art as indicted at a lower side of a broken line of FIG. 2, whereby in place of the work channel of the optical fiber 31-2 in which a trouble occurs, the protection channel of the optical fiber 31-1 constituting the first 2F-BLSR together with the optical fiber 31-2 is applied as indicated by a one-dotted chain line and a heavy solid line in FIG. 4.

That is, the state that the ring switching described above is started is identified as a state where it is difficult to maintain the span switching which was precedently carried out at the time point when a ring switching request is given to any one of the first and second 2F-BLSR, and the ring switching concerned is carried out on the same procedure as the prior art.

Accordingly, according to this embodiment, the transmission bands of the first and second 2F-BLSR are effectively used without losing the compatibility with 2F-BLSR which is relating to information delivered through the APS channels, and high reliability can be kept.

Furthermore, in this embodiment, by combining the first and second 2f-BLSRs, both the ring switching and the span switching can be performed without losing the original characteristics of these 2F-BLSRs.

Still furthermore, in this embodiment, SF-P (=1111) is not contained as a value of switch request in information delivered through the APS channel of any one of the first and second 2F-BLSRs, and also the node device 10-X (controller 14-X) identifies the above-described SF-R (=1011≠1111) in place of SF-P.

That is, the node device 10-X (controller 14-X) can identify LP-S defined as the same value (=1111) as SF-P without confusing LP-S with SF-P as shown in FIGS. 3 and 8. Accordingly, since SF-P and LP-S are defined as a value (=1111) of the same upper K1 byte, it is possible to prevent occurrence of a not normal state that a node device in a fiber through state is present although no ring switching is carried out, which occurs in the prior art.

Furthermore, in each of the embodiments described above, since the work channel and the protection channel are secured in each optical fiber by combining the first and second 2F-BLSRs, the number of channels affected by troubles of individual optical fibers is reduced by half as compared with 4F-BLSR in which a work channel and a protection channel are formed through an individual optical fiber.

Accordingly, according to the invention, reduction in transmission capacity and service quality which are caused by troubles of not only the optical fibers 32-1 to 32-4, but also the interface portions 33-X1 to 33-X4 corresponding to the optical fibers can be dispersed.

In this embodiment, the ring switching request is manually given.

However, the ring switching request as described above is automatically given under the supervisory control associated with the states of the node devices 10-A to 10-D and the optical fibers 31-1 to 31-4.

Furthermore, in this embodiment, the ring switching in one 2F-BLSR different from the other 2F-BLSR which is targeted to the ring switching request in the first and second 2F-BLSRs is preferentially carried out.

However, the invention is not limited to the above construction. When complication of the processing carried out in each node device is permitted, the ring switching having the same level as the ring switching carried out in 4F-BLSR can be implemented by effectively combining and practically using information delivered through the APS channels of both the first and second 2F-BLSRs.

Furthermore, in each of the above-described embodiments, the combination and upgrade (which does not accompany stop of the operation) of the existing two systems can be implemented on the basis of the following procedures (1) and (2).

(1) In all the node devices 10-A to 10-D, a new interface portion is mounted (expanded) in each of slots 3, 4 different from slots 1, 2 which are respectively mounted in two interface portions constituting existing 2F-BLSR (herein, it is assumed to operate as the first 2F-BLSR)

(2) In all the node devices 10-A to 10-D, the interface portions mounted in the respectively slots 3 and 4 and the optical fibers 31-3 and 31-4 connected to the interface portions are operated as existing second 2F-BLSR.

Accordingly, each of the above-described embodiments is implemented by a simple upgrade work (containing the above expansion) which is carried out without accompanying the stop of the operation of the existing 2F-BLSR and the change of the cross-connect. Therefore, it can be avoided that instantaneous breaking of signals which occur in the work channel and the protection channel during the upgrade process of the prior art, and also the ring switching in the first 2F-BLSR under operation can be performed even during the upgrade process.

### Third Embodiment

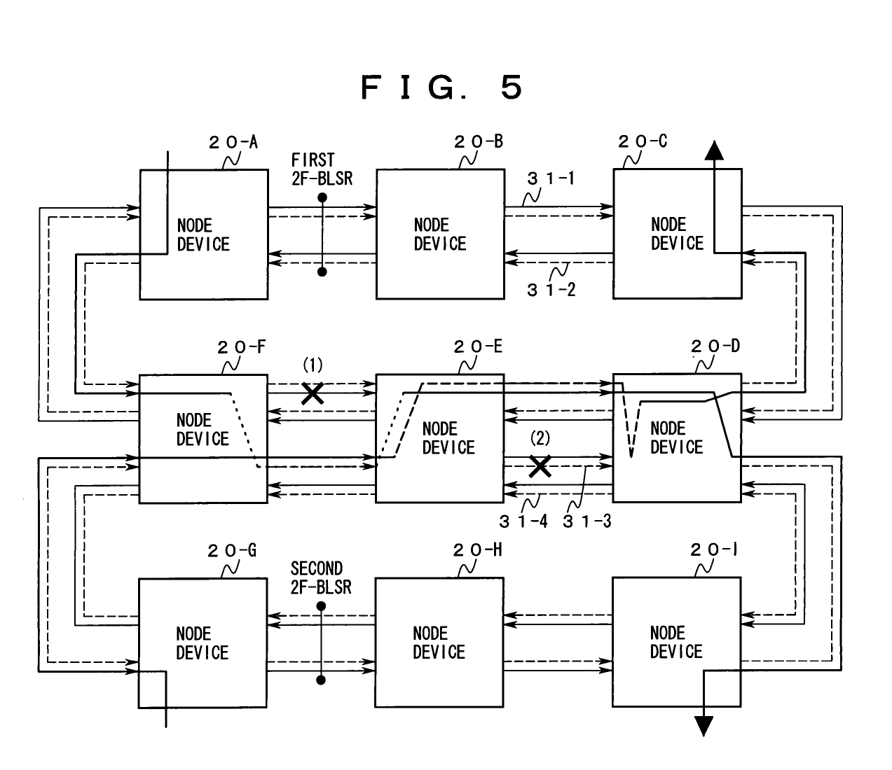

FIG. 5 is a diagram showing a third embodiment according to the invention.

In FIG. 5, each of optical fibers 31-1, 31-2 is annularly laid down so that the transmission directions thereof are opposite to each other. Six node devices 20-A to 20-F are disposed in annular transmission lines comprising these optical fibers 31-1, 31-2. The node devices 20-D to 20-F of the node devices 20-A to 20-F are disposed annular transmission lines which are individually formed of the optical fibers 31-3, 31-4, and each of these optical fibers 31-3, 31-4 is annularly laid down so that the transmission directions thereof are opposite to each other. Furthermore, three node devices 20-G, 20-H and 20-I are disposed in a transmission section which is sandwiched between the node devices 20-D and 20-F in the transmission sections of the optical fibers 31-3, 31-4 and also in which the node device 20-E is not interposed.

The operation of the third embodiment according to the invention will be described with reference to FIG. 5.

The node devices 20-D to 20-F out of the node devices 20-A to 20-I are designed in the same configuration as the node device 10-A shown in FIG. 1, and have the same function as the node device 10-A.

The node devices 20-A to 20-C, 20-G to 20-I other than the node devices 20-D to 20-F out of the node devices 20-A to 20-I are designed in the same configuration as the node device 32-A and have the same function as the node device 32-a shown in FIG. 6.

Furthermore, the optical fibers 31-1, 31-2 and the node devices 20-A to 20-F function as the first 2F-BLSR in the first and second embodiments, and the optical fibers 31-3, 31-4 and the node devices 20-D to 20-F, 20-G to 20-I function as the second 2F-BLSR of the first and second embodiments.

However, these first and second 2F-BLSRs function as communication systems which have commonly sites (office premises) in which the node devices 20-D to 20-F are set up because the node devices 20-A to 20-I are set up at different sites (premises).

Furthermore, the node devices 20-D to 20-F interposed in both the first and second 2F-BLSR carry out the span switching between these 2F-BLSRs as in the case of the first embodiment without cooperating with the node devices 20A to 20-C, 20G to 20-I.

In the process of the ring switching, the node devices 20-D to 20-F cooperate with the node devices 20-A to 20-C and the node devices 20-G to 20-I.

Accordingly, for example, a trouble occurring in the transmission section extending from the node device 20-F to the node device 20-E (FIG. 5(1)) of the transmission section of the optical fiber 31-2 which constitutes the first 2F-BLSR is relieved under span switching by practically using the second 2F-BLSR as indicated by a heavy broken line of FIG. 5.

Furthermore, among the transmission sections of the optical fiber 31-3 which forms the second 2F-13LSR, the transmission section extending from the node device 20-E to the node device 20-D (FIG. 6(2)) has a trouble. The trouble is relieved through span switching by using the first 2F-BLSR as indicated by a heavy wavy line of FIG. 6.

That is, the first and second 2F-BLSR are configured redundantly in only the section where the node devices 20-D to 20-F are interposed.

Accordingly, according to this embodiment, a desired communication system configured redundantly in only a transmission section to which high reliability is required can be flexibly architected in a limited cost range.

In each of the above-described embodiments, the transmission system is configured by combining two 2F-BLSRs. However, the invention is not limited to this construction, and the transmission system may be configured by combining three or more 2F-BLSRs. For example, the invention is able to realize high durability to troubles which is not achievable by 4F-BLSR, by including four paths for span switching as protection channels in addition to a single path for ring switching.

The invention is not limited to the above embodiments and various modifications may be made without departing from the spirit and scope of the invention. Any improvement may be made in part or all of the components.

What is claimed is:

1. A node device disposed in each of a plurality of annular transmission lines whose transmission bands are assigned to an active band and a reserve band and each of which is bi-directionally formed of two optical fibers for transmission in different directions from each other, the node device comprising
a controller substituting, when a failure occurs in a preceding transmission section of one of the plurality of annular transmission lines but not in the rest of the annular transmission lines, any reserve band of the rest of the annular transmission lines for an active band of the preceding transmission section with the failure therein.

2. The node device according to claim 1, wherein
when a failure occurs in a preceding transmission section of one of the plurality of annular transmission lines as well as in the rest of the annular transmission lines, the controller substitutes a reserve band of a transmission section subsequent to the preceding transmission section for an active band of the preceding transmission section.

3. The node device according to claim 1, wherein:
the controller identifies, as a combination of status information, a situation that no failure occurs in the rest of the annular transmission lines, the status information being delivered among node devices disposed in the plurality of annular transmission lines; and
as a reserved piece of the status information, the controller issues a request for the substitution of the preceding transmission section to other node devices via the preceding transmission section and receives a response to the request from the other node devices via the preceding transmission section.

4. The node device according to claim 1, wherein
in response to a request for ring switching, the controller cooperates with the other nodes prior to a start of the ring switching via one of the plural annular transmission lines which is not subject of the ring switching and is one with no failure, the request for ring switching being supplied through a preceding transmission section of one of the plurality of annular transmission lines or supplied from an exterior.

5. A communication system comprising:
a plurality of first node devices disposed in each of a plurality of annular transmission lines whose transmission bands are assigned to an active band and a reserve band and each of which is bi-directionally formed of two optical fibers for transmission in different directions from each other, the first node devices each comprising a controller substituting, when a failure occurs in a preceding transmission section of one of the plurality of annular transmission lines but not in the rest of the annular transmission lines, any reserve band of the rest of the annular transmission lines for an active band of the preceding transmission section with the failure therein; and
a second node device disposed in any of the plurality of annular transmission lines which are configured as BLSR.

6. A redundancy configuration method for a node device which is disposed in each of a plurality of annular transmission lines whose transmission bands are assigned to an active band and a reserve band and each of which is bi-directionally formed of two optical fibers for transmission in different directions from each other, the method comprising the step of
when a failure occurs in a preceding transmission section of one of the plurality of annular transmission lines but not in the rest of the annular transmission lines, substituting any reserve band of the rest of the annular transmission lines for an active band of the preceding transmission section with the failure.

7. The redundancy configuration method according to claim 6, further comprising the step of
when a failure occurs in a preceding transmission section of one of the plurality of annular transmission lines as well as in the rest of the annular transmission lines, substituting a reserve band of a transmission section subsequent to the preceding transmission section for an active band of the preceding transmission section.

8. The redundancy configuration method according to claim 6, further comprising the step of:
identifying, as a combination of status information, a situation that no failure occurs in the rest of the annular transmission lines, the status information being delivered among node devices disposed in the plurality of annular transmission lines; and
as a reserved piece of the status information, issuing a request for the substitution of the preceding transmission section to other node devices via the preceding transmission section and receiving a response to the request from the other node devices via the preceding transmission section.

9. The redundancy configuration method according to claim 6, further comprising the step of
in response to a request for ring switching, cooperating with the other nodes prior to a start of the ring switching via one of the annular transmission lines which is not subject of the ring switching and is one with no failure, the request for ring switching being supplied through a preceding transmission section of one of the plurality of annular transmission lines or supplied from an exterior.
